(19) United States
(12) Patent Application Publication
(10) Pub. No.: US 2004/0068445 A1
(43) Pub. Date: Apr. 8, 2004

(54) Solution brokerage

(76) Inventor: Klaus Salewski, Krefeld (DE)

Correspondence Address: BAYER POLYMERS LLC, 100 BAYER ROAD, PITTSBURGH, PA, 15205, US

(21) Appl. No.: 10/447,409

(22) Filed: May 29, 2003

Related U.S. Application Data
(60) Provisional application No. 60/385,711, filed on Jun. 4, 2002.

(51) Int. Cl. G06F 17/60

(52) U.S. Cl. 705/26

(57) ABSTRACT

The invention relates to methods and a computer system for marketing goods. In a first method, a client selects an appropriate product by means of a consulting software. In a second method, a client determines the properties, processing parameters, design parameters, or performance characteristics of a certain product by means of a consulting software. In each method, the utilization of that consulting software is quantified and the quantity is stored. Furthermore a rebate is credited to the client depending on that quantity. The software on which both methods are based is installed on a computer system. The client can connect to the computer system via a digital network.

### FIELD OF THE INVENTION

This is a Non-Provisional Application of a Provisional Application of U.S. Serial No. 60/385,711, filed Jun. 4, 2002.

The present invention relates to the marketing of goods sold or produced by a company, and more particularly to the field of “attention brokerage”. The present invention specifically relates to quantifying the utilization of a consulting software and crediting a rebate depending on the utilization of the consulting software.

### BACKGROUND OF THE INVENTION

McCarthy's four P's “Product, Price, Promotion and Place” are the basis of traditional and modern marketing. However, they must be adapted to the changed conditions and developed further. Modern markets will be shaped by the direct personalized dialogue with the customer. The new concepts and the principles of marketing are fostered by the use of digital technology.

In traditional marketing, the environment is fundamentally linear in nature. Every step follows another in a logical order. For example, a company conducts market research in order to find out what products or services are demanded by the consumers. The market researcher also investigates what competitors are doing and whether there are any gaps in the marketplace. Based on these findings, the company develops a new product and manufactures a small test run. The products are then shipped to stores and advertised in a small test market. Customers learn about this new product from television or radio and buy it. Depending on the sales volume, the company may decide to manufacture the product.

In modern marketing, companies focus no longer on satisfying the average customer, but apply the “mass customization” principle. Goods and services are developed, manufactured and marketed in an inexhaustible variety and customized. In mass customization, innovative technologies and management techniques are applied. Until recently, mass customization has been mainly limited to manufacturing. Complex production planning and manufacturing methods such as flexible manufacturing cells, computer-integrated control systems, computer-aided design, just-in-time concepts, totally quality management enabled ever smaller batch sizes, ever shorter set up and throughput times, and ever more flexible and faster reaction possibilities on individual customer demands without having significant cost increases.

Nowadays, marketing has to be reconsidered in the light of recent multimedia developments. In e-commerce, market research, product development, and customer feedback can take place concurrently. A customer is involved in the development of the product. In e-commerce, customer relevant data can be collected and analyzed at low cost. Hence, customized service and information can be used in order to retain customers.

### SUMMARY OF THE INVENTION

The fundamental premise of the present invention is that a consumer's attention is the valued commodity. It is especially suited for the solution of customer specific problems. It is therefore called “solution brokerage”. In essence, the present invention provides marketing methods, which can be integrated in a computer system and used in e-commerce:

A client erects a digital network connection between his computer and the computer of a company selling or purchasing designated goods. The client accesses a consulting software in order to select an appropriate product or in order to determine the properties, processing parameters, design parameters, or performance characteristics of a certain product. The utilization of the consulting software by the client is quantified. The quantity is stored. In the event the client decides to buy a product manufactured or sold by the company, the client is credited a rebate. The rebate depends on the utilization of the consulting software by the client. The rebate motivates a client to use the consulting software extensively and to be well-informed about the products sold or produced by the company.

### BRIEF DESCRIPTION OF THE DRAWINGS

FIG. 1 shows a network diagram of the computer system for marketing goods,

FIG. 2 shows a flow chart of the first method for marketing goods,

FIG. 3 shows a block diagram of a hybrid neural network,

FIG. 4 shows a flow chart of the second method for marketing goods,

FIG. 5 shows a flow chart of an example for the second method.

### DETAILED DESCRIPTION OF THE INVENTION

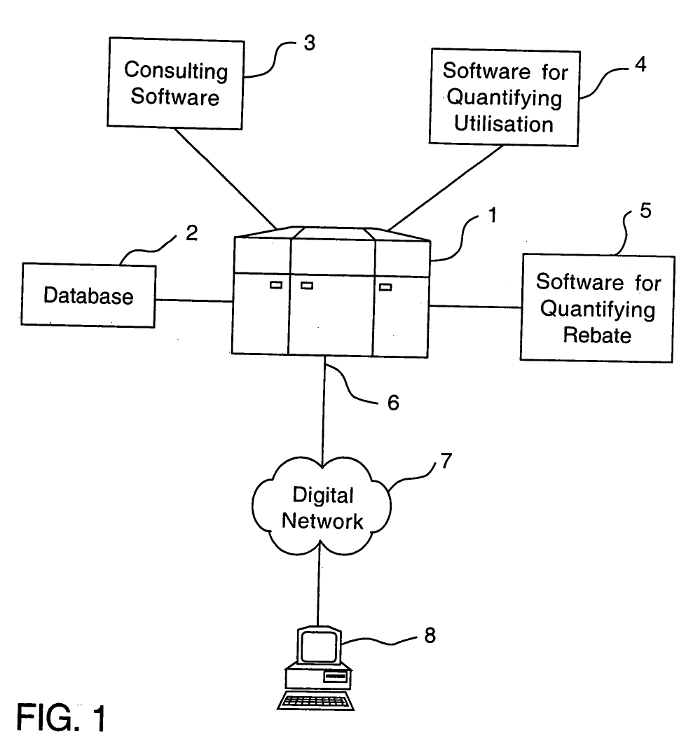

An embodiment of the computer system for marketing goods is illustrated in FIG. 1. The computer system 1 includes the following components:

a database 2 for storing information about clients,

a consulting software 3 for selecting a product or determining properties, processing parameters, designed parameters, or performance characteristics of a certain product,

a software 4 for determining a quantity for the utilization of the consulting software and for storing the quantity in the database 2,

a software 5 for quantifying a rebate for a certain product depending on the utilization of the consulting software.

As shown in FIG. 1, a connection 6 to a digital network 7 enables the data transfer between the computer system 1 and the computer 8 of a client. The computer system 1 can contain an arbitrary number of computers. The installation of the database and the three software programs on these computers is arbitrary as long as their operability is guaranteed.

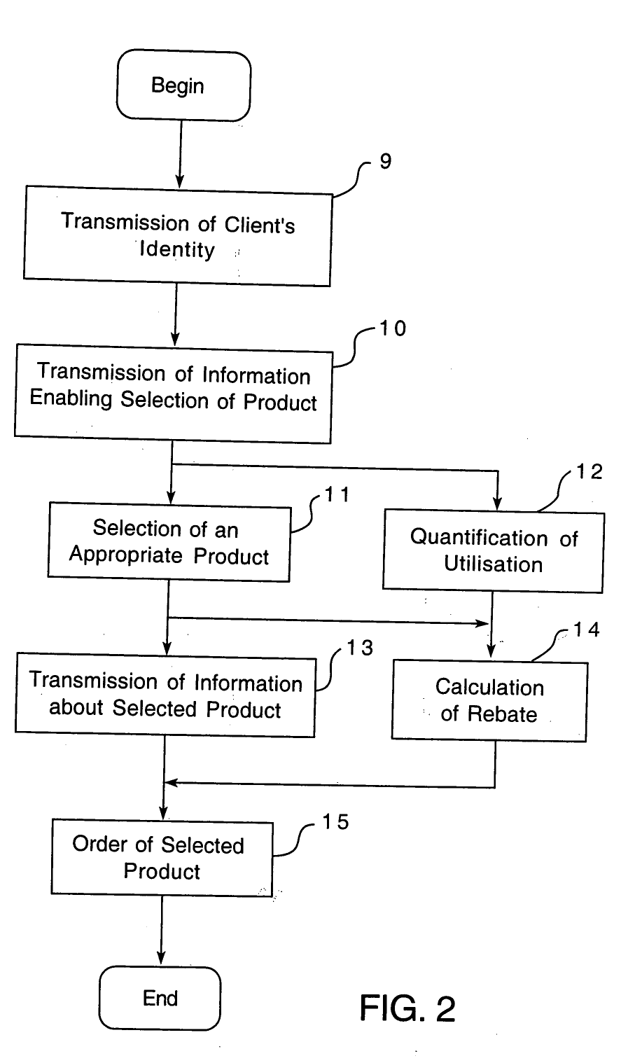

A flow chart of the first method for marketing goods is shown in FIG. 2. In this example, the client is identified after connecting to the computer system of the company (step 9). For the identification of the client, data is transmitted from the client's computer to the computer system. The client may have to enter their user name and password in an access control screen. Alternatively, the client may be identified by data stored on their computer and, which is sent automatically to the computer system of the company when the client logs on. Then, the client enters information enabling the selection of a product in a further screen. This data is transferred from the client's computer to the computer system (step 10). The consulting software now selects an appropriate product (step 11). The selection process may be interactive and the client may be asked to enter more details specifying the product.

This method is especially useful for companies offering a wide range of similar goods, which is typical of a producer of materials or plastics. For example, plastic parts produced by injection molding and used in the automotive industry often must have a certain color depending on its composition. The consulting software enables the client, in this case a manufacturer of automobiles or supplier of the automotive industry, to calculate the processing time and the shrinkage of the molded part, or to simulate the admissible stress for a certain material and part design, or to find out a suitable choice of materials for a maximum stress and a certain part design. The client can vary the mold or the part design until the client finds the optimal solution. Additionally, the consulting software can provide the client with additional information such as alternative part design or modified materials for a certain application or other properties for a specified material.

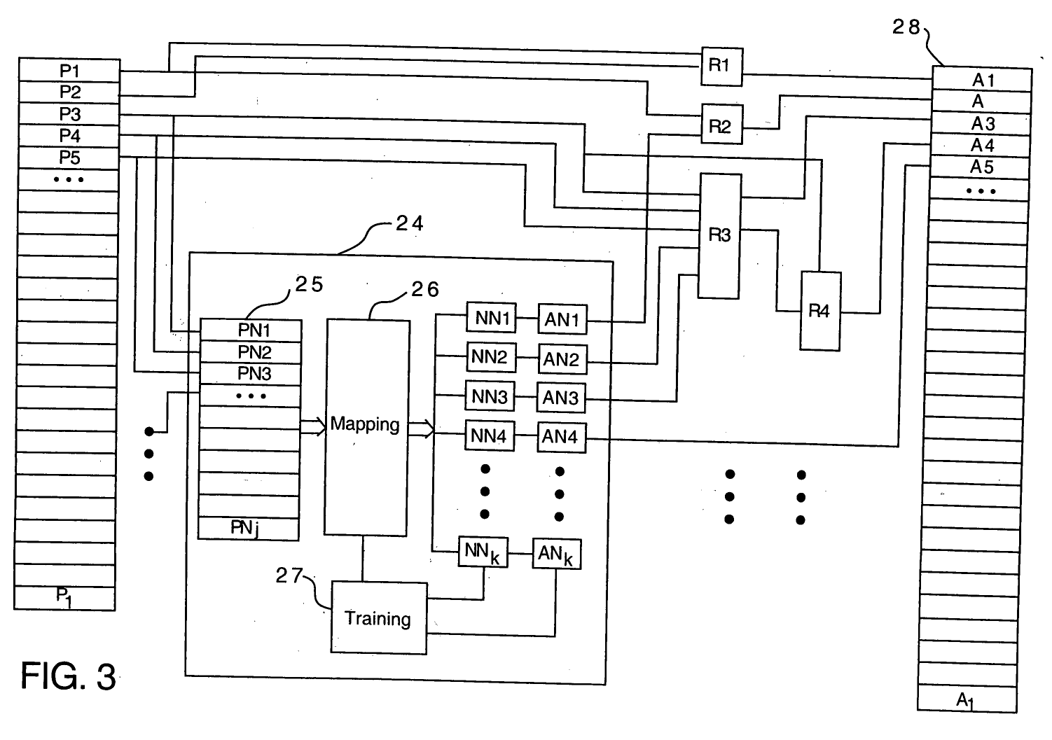

In a preferred embodiment of the invention, the consulting software is based on a hybrid neural network. The exemplary hybrid neural network in FIG. 3 has an input 23 for any variables P1, P2, P3, . . . Pᵢ concerning a material, design or process. Additionally, it has a neural network module 24 with an input 25 for the parameters PN1, PN2, PN3, . . . PNⱼ. The input 25 is connected to the input 23.

Therefore, the parameters PN1, PN2, PN3, . . . PNⱼ are a subset of the parameters P1, P2, P3, . . . Pᵢ. In the given example, the parameters PN₂ and PN₃ are identical with the parameters P₄ and P₅, respectively.

The input 25 of the neural network module is connected to the mapping module 26 and the mapping module again with the neural networks NN1, NN2, NN3, . . . NNₖ with the outputs AN1, AN2, AN3, . . . ANₖ. Each neural network is trained for the prognosis of a particular quality given at the output when the required parameters are entered at the input. The mapping module 26 provides the neural networks with the required parameters belonging to the parameters PN1, PN2, PN3, . . . PNⱼ.

Additionally, the neural network module has the training module 27 connected to the mapping module 26 and the neural networks NN1, NN2, NN3, . . . NNₖ and their outputs. The training module 27 is active only in training modus. The training of the neural networks can be sequential, i.e. each neural network is trained individually by entering the required parameters. A suitable training method is described in “On a class of efficient learning algorithms for neural networks” by F. Bärmann and F. Biegler-König (Neural Network, Vol. 5,pp. 139-144, 1992).

Furthermore, the hybrid neural network contains the rigorous models R1, R2, R3, . . . Rⱼ. Rigorous models are partial models and can be represented by mathematical equations. Those parts of the model, which cannot be written as mathematical formulas, are represented by the neural network module. The rigorous models can be interconnected and connected to the neuronal network module. In the given example, the rigorous model R1 is only connected to the input 23, but not to the outputs of the neural network modules or the other rigorous models. The output of the rigorous model R1 is connected to port A1 of the output 28. In contrast, the rigorous model R1 is connected to the input for the parameter P1 and the output An1 of the neuronal network module 24. The output of the-rigorous model R2 is connected to the output A2. The rigorous model R3 is connected to the inputs for the parameters P3, P4, and P5 and the outputs AN2 and AN3 of the neural network modules 24. The two inputs for the rigorous model R4 are connected to an input for the parameter P3 and the output of the rigorous model R3. The output of the rigorous model is connected to the output A4.

The utilization of the consulting software by the client is simultaneously quantified (step 12, see FIG. 2). Possible quantities for the utilization of the consulting software by the client are:

the duration for which the consulting software runs,

the number of arithmetic operations performed by the consulting software,

the duration of the arithmetic operations performed by the consulting software,

the number of accesses to the consulting software by the client.

Furthermore, the information about the product selected by the consulting software is transmitted from the computer system to the computer of the client (step 13).

The quantity for the utilization of the consulting software is used in order to calculate a rebate (step 14), the amount of, which increases with the increasing utilization of the consulting software. The expenditures for marketing constitute a certain percentage of the price for a product. The fraction of these expenditures saved by the application of “solution brokerage” is the maximum rebate credited to a client for using the consulting software.

However, an event may occur wherein the company may not, or cannot sell or produce an appropriate product. In this case, the contact details of a consultant or an e-mail link to the consultant may be automatically displayed. Alternatively, a message with details about an appropriate product and about the client may automatically be sent to a consultant or the client may be advised to buy a product from another company. Finally, the client can order the product selected by the consulting software (step 15). The client is credited a rebate depending on the utilization of the consulting software.

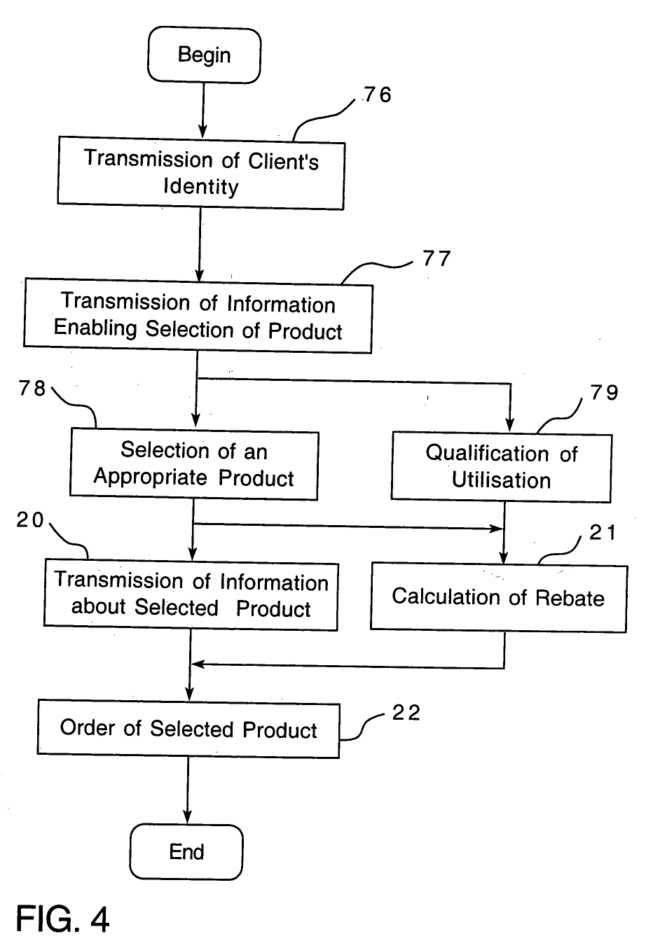

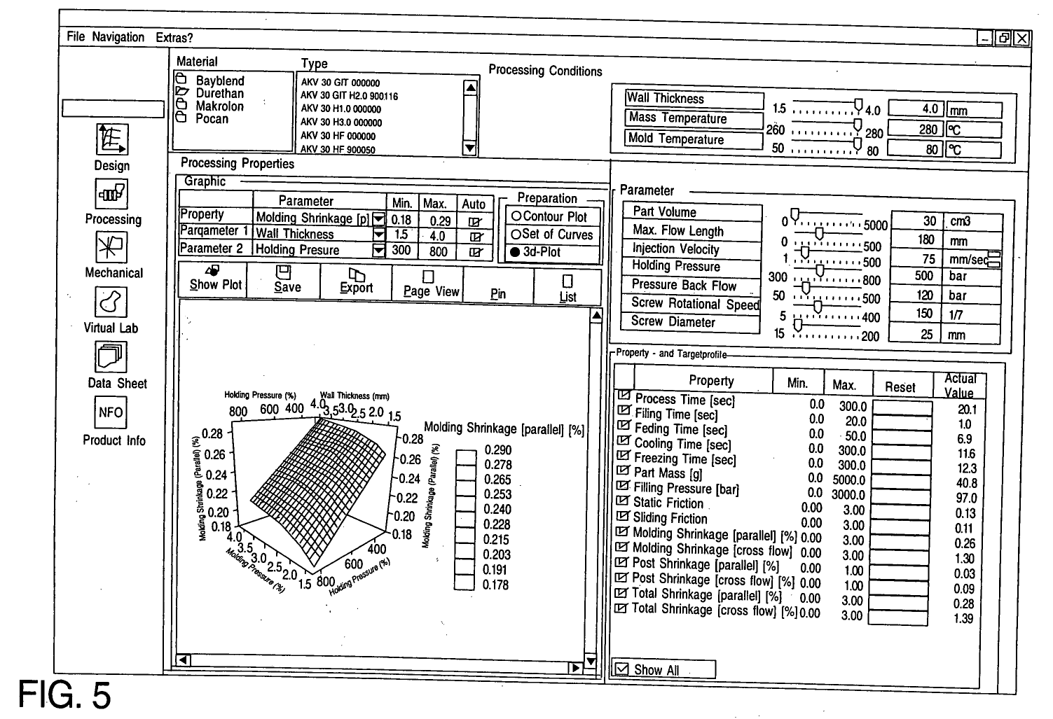

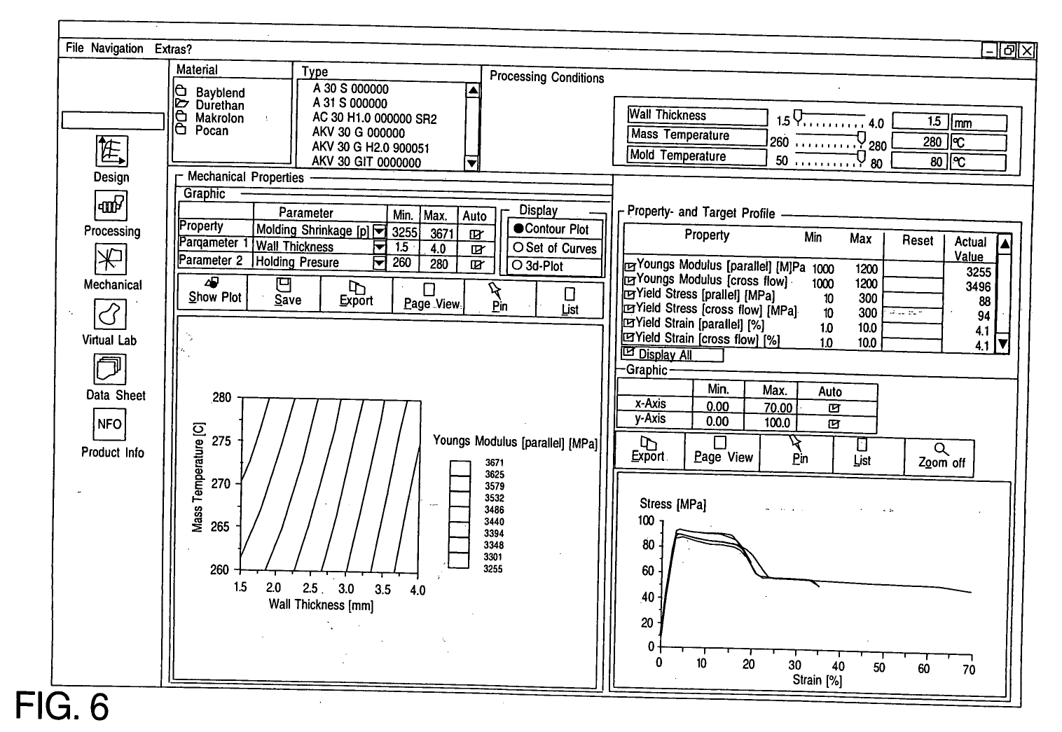

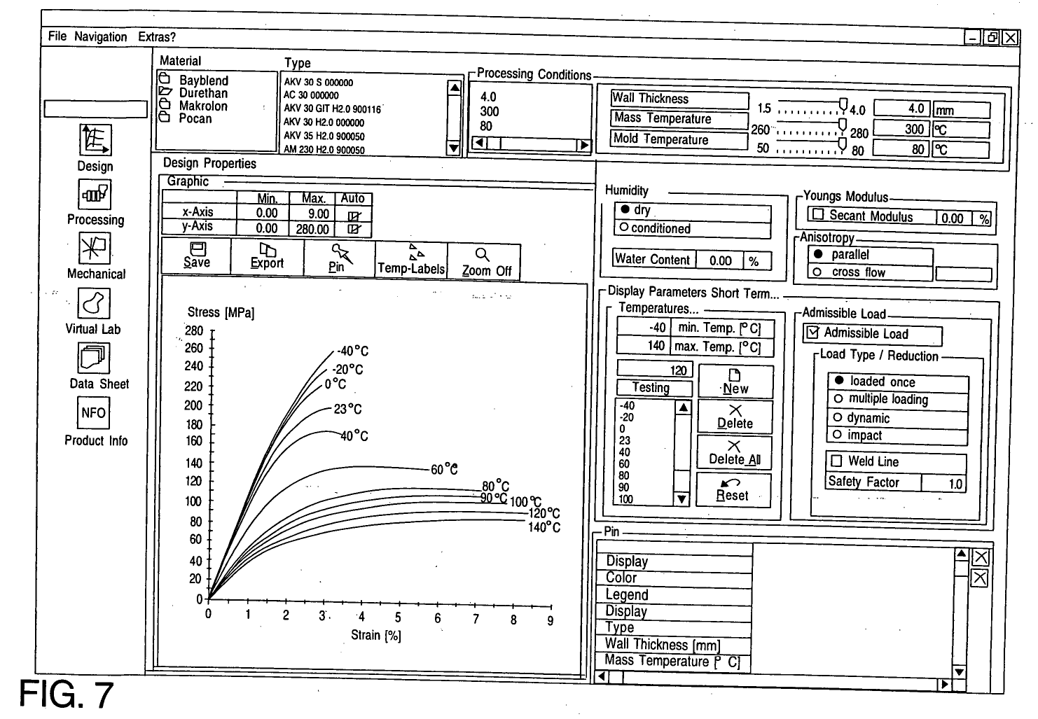

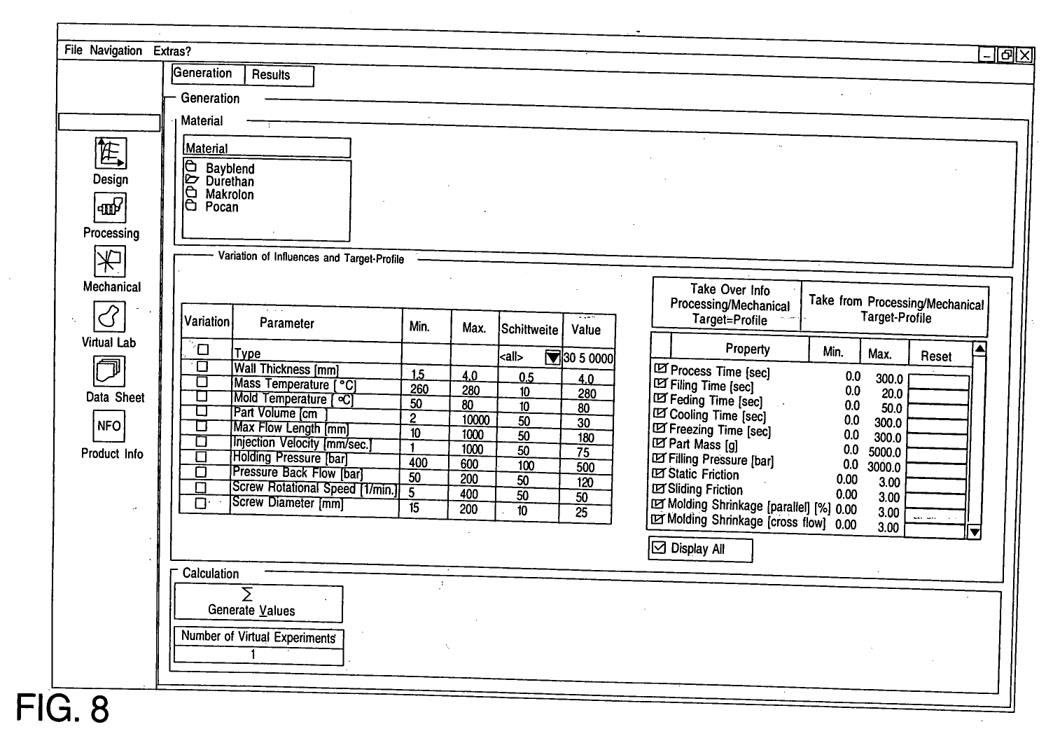

A flow chart of the second method for marketing goods is shown in FIG. 4. The flow chart has the same structure as the one given in FIG. 2. Both methods are distinguishable from each other by the processed information. The client is identified in the same way as identified in the previous method (step 16). However, the client, in this case, already knows the identity of the product in which he or she wants to obtain more information. Instead of entering information enabling the selection of a product, the client enters information relating to the selection of a certain product, such as properties, processing parameters, design parameters or performance characteristics of the product. For example (see FIG. 5), a client, who has bought a certain slimming product and wants to find out how to achieve a certain weight loss per week, first specifies the product, which was bought (step 29). After entering the client's personal details (step 30) and the weight loss the client intends to achieve (e. g. 1 kilogram per week, step 31), the client is given a customized dietary plan (step 32). In step 33, the client may be given further advice.

Additionally, the second method may be used in connection with the first method for the product selected by the first method. However, in this case, it is not necessary that all steps of method 1 and 2 are performed. A gradual transition of step 11 of method 1 to step 17 of method 2 is possible. The transition may not always be abrupt and clear as method 1 and can contain interactive elements, e.g., the client wants to find out whether a gas injection molding process or a conventional injection molding process is preferable for a product consisting of a plastic with the components selected by the first method and what the differences are. Thus, the client enters more details about critical design parameters.

The relevant data is transmitted from the computer of the client to the computer of the company (step 17). Now, the consulting software determines which method is more suitable (step 18). This process may as well be interactive and the client may be asked to enter more information relating to the selection of the product. As soon as it is decided whether conventional molding or gas injection molding is preferable, the client can ask for more details about the properties, processing parameters, design parameters or performance characteristics of the product. Finally, the client might even find out that welding is far better suited than molding. The client would have to start again choosing a plastic with the desired color used in welding.

The utilization is quantified in the same way as for method 1 (step 19) and the information about the properties, processing parameters, design parameters or performance characteristics is transmitted from the computer to the computer of the client (step 20). The quantity for the utilization is again used in order to calculate a rebate (step 21). The client can again order the product with the selected properties, processing parameters, design parameters or performance characteristics (step 22). In that the event the company does not sell or produce an appropriate product, the client may contact a consultant as in method 1 or the client may be advised to buy a product from another company.

### EXAMPLE 1

An example of the method according to the present invention is presented, demonstrating the functionality and benefits resulting from the computer-implemented method of the present invention. Screen shots of this example embodiment are illustrated in FIGS. 5 to 8.

FIG. 5 shows a combined input/output window 100 which enables a user to enter information relating to the selection of a certain product (cf. step 17 of FIG. 4). For example input/window 100 is remotely accessed by a user via the internet.

In the example considered here the user intends to purchase a polymer product to be used for the fabrication of a part in an injection moulding process. In order to specify the selected product the user enters the following information into input/window 100:

1. Select Material:

The user can choose any one of the listed polymer materials, i.e. Bayblend, Durethan, Makrolon, Pocan. In the example considered here the user has selected the greyed item which is Durethan.

2. Select Type:

Any one of the materials which can be selected by the user in the first step can have numerous types for various applications, such as with or without UV-stabiliser, with or without glass fibre, inflammable or non-inflammable, etc.

In the example considered here the user has selected the grade type ‘AKV 30 H1.0000000’.

3. Select Processing Conditions:

Here the user needs to enter the wall thickness of the injection moulding tool which is to be used for the fabrication of the part. In the example considered here the wall thickness is 4,0 mm. Further the user needs to enter the mass temperature, which is 280° C., and the mould temperature, which is 80° C., in the example considered here.

4. Select Processing Parameters:

Here the user needs to enter the processing parameters of the injection moulding process which are determined by the injection moulding tool and the injection moulding machine the user intends to use for the process. In the example considered here these parameters are ‘part volume’. ‘maximum flow length’, ‘injection velocity’, ‘holding pressure’, ‘pressure backflow’, ‘scew rotational speed’ and ‘screw diameter’. The respective values the user has entered are 30 cube centimetres, 180 mm, 75 mm per second, 500 bar, 120 bar, 150 1/minute and 25 mm.

5. Optional: Select Min/max Range:

In the box ‘Property-and Targetprofile’ the number of properties is listed i.e. process time, filling time, feeding time, cooling time, freezing time, part mass, filling pressure, static friction, sliding friction, moulding shrinkage (parallel), moulding shrinkage (cross flow), post shrinkage (parallel), post shrinkage (cross flow), total shrinkage (parallel) and total shrinkage (cross flow).

In the column ‘minimum’ the user can enter desired minimum values of these properties and in the column ‘maximum’ the user can enter desired maximum values of these properties. This is however optional and not required to perform a simulation.

6. Select Graphic:

Here the user can select any one of the parameters, i.e. wall thickness, mass temperature, mould temperature, part volume, maximum flow length, injection velocity, holding pressure, pressure backflow, screw rotational speed or screw diameter as ‘parameter 1’ and a second one of these parameters as ‘parameter 2’. This choice of parameters 1 and parameters 2 determines the X and Y axis of output graphics 102. In the example considered here the user has selected ‘wall thickness’ as parameter 1 and holding pressure as ‘parameter 2’.

Further the user can select one of the properties as the Z-coordinate. In the example considered here the user has selected ‘moulding shrinkage (parallel)’.

Further, the user can select ‘auto’ for automatic scaling of the X, Y and Z coordinate axis. A1ternatively the user can set the coordinate ranges to be displayed by entering ‘min’ and ‘max’.

In the box ‘Preparation’ the user can select the graphic format i.e. ‘Contour Plot’, ‘Set of Curves’ or ‘3d-Plot’. In the example considered here the user has selected ‘3d-Plot’.

After these data have been entered a simulation programme is started which provides the output graphics 102. This simulation programme can be based on a neural network or a hybrid neural (cf. FIG. 3). Further, the right most column of box ‘Property-and Targetprofile’ of input/output window 200 shows the numerical values of the simulated results for these properties.

Next the user clicks on icon ‘mechanical’ in the left most column of input/output window 100. In response input/output window 200 which is shown in FIG. 6 is displayed. By means of the input/output window 200 the user can obtain a simulation result for the mechanical properties of the part which is produced on the basis of the selected material type (steps 1 and 2) and on the basis of the selected processing conditions and parameters (steps 3 and 4). The additional simulation results relate to the mechanical properties ‘Youngs Modulus (parallel)’, ‘Youngs Modulus (cross flow), yield stress (parallel), yield stress (cross flow), yield strain (parallel) and yield strain (cross flow in percentages). The right most column of box ‘Property-and Targetprofile’ of input/output window 200 shows the numerical values of the simulated results for these properties.

On the basis of input/output window 200 the user can perform additional input operations:

7. Optional: Select Min/max Range.

This step is equivalent to step 5 (cf. FIG. 5). In column ‘minimum’ of the Property- and Targetprofile box the user can enter the desired minimum values of the properties and in the column ‘maximum’ the user can enter the corresponding maximum values.

8. Select Graphic:

Here the user can specify the scaling of output graphics 202 which shows stress-strain curves. The user can select either automatic scaling, i.e. ‘auto’ or specify coordinate ranges to be shown in output graphics 202.

9. Select Graphic:

This is equivalent to step 6 of FIG. 5 with the difference that a mechanical property from box ‘Property-and Targetprofile’ of input/output window 200 can be selected by the user as the third coordinate. In the example considered here the user has selected ‘Youngs Modulus (parallel)’ as the third coordinate. The simulation result is shown in colour coded output graphics 204.

By clicking on the icon ‘design’ in the left most column of input/output window 200, input/output window 300 of FIG. 7 is opened. The user can enter additional parameters and specifications as a basis for a further simulation of the design properties of the part which is produced on the basis of the processing properties entered via input/output window 100 of FIG. 5:

10. Select Humidity/Youngs Modulus/Anisotropy:

Here the user can enter the humidity condition, i.e. ‘dry’ or ‘conditioned’, Youngs Modulus and Anisotropy i.e. ‘parallel’ or ‘cross flow’.

11. Select Temperatures:

Here the user can select or enter temperatures for which the simulation of the design properties is to be performed.

12. Select Load Type:

Here the user can specify the type of loading of the part.

13. Select Graphic:

Here the user can specify the scaling of the X and Y axis of output graphics 302. Output graphics 302 shows a set of stress-strain curves for the various temperatures as specified in step 11. Output graphics 302 is generated by a simulation programme which performs the simulation on the basis of the user provided input parameters.

By clicking on item ‘virtual lab’ in the left most column of input/output window 300, window 400 shown in FIG. 8 is opened. Here the user can perform the following input operations:

14. Select Parameter:

One or more of the processing parameters (cf. step 3 and 4 of FIG. 5) can be selected from the parameter list.

15. Select Min/Max Range:

Here the user can specify desired minimum and maximum values for the resulting properties.

In response the simulation program simulates the properties on the basis of the parameter values while the selected parameters (step 14) are varied in incremental steps. Those parameter combinations which result in properties within the user specified range (step 15) constitute the result space. The result space can be viewed by the user by clicking on tab ‘results’ (step 16).

On the basis of these simulations the user will finally select a specific material of a specific type for purchasing. The amount of usage of the simulation software prior to the purchase decision is tracked. This usage amount determines a rebate for the user's purchase of the selected material.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A computer-implemented method for maintaining a business relationship between a seller and a client in an arrangement comprising a plurality of computers connected to a digital network, said network carrying digital information between said computers, said computers comprising at least one computer associated with at least one client and at least one computer associated with a seller, said computer associated with at least one client having at least one display device enabling a visual display containing the digital information delivered to said computer of the client via said network and at least one input device, said input device enabling the client to erect a network connection to said computer of said seller, comprising the steps of
a) transmitting a first information comprising the identity of said at least one client from said computer associated with at least one client to said computer associated with the seller;
b) transmitting a second information comprising the selection of a product from said computer associated with at least one client to said computer associated with the seller;
c) selecting an appropriate product by means of a consulting software;
d) transmitting a third information about the selected product from said computer associated with the seller to said computer associated with at least one client;
e) determining a quantity of the utilization of said consulting software by said client;
f) storing said quantity.

2. A computer-implemented method according to claim 1 comprising additional step of ordering said product wherein a rebate is credited to said client, said amount of rebate is dependenton the amount of utilization of the method by client.

3. A computer-implemented method according to claim 1 wherein the rebate depends additionally on further usage information of the client.

4. A computer-implemented method according to claim 1, wherein said client is identified by username and password or by digital information stored on the computer associated with the client and transferred to the computer associated with the seller.

5. A computer-implemented method according to claim 2 comprising the additional step of ordering said product wherein a rebate is credited to said client depending on the utilization of the consulting software by said client.

6. A computer-implemented method according to claim 5, wherein said consulting software verifies whether said company sells or fabricates a product which corresponds to the specifications of said client.

7. A computer-implemented method according to claim 6, wherein the contact details of a consultant are automatically displayed, or an email link to a consultant is automatically displayed, or a message is automatically sent to a consultant with details about said product and about said client, or said client is advised to buy a product from another company if said company does not sell or fabricate said product.

8. A computer-implemented method according to claim 2 wherein the duration for which the consulting software runs, or the number of arithmetic operations performed by the consulting software, or the duration of the arithmetic operations performed by the consulting software, or the number of accesses to the consulting software is used for quantifying the utilization of the software by the client.

9. A computer-implemented method for maintaining a business relationship between a seller and a client in an arrangement comprising a plurality of computers connected to a digital network, said network carrying digital information between said computers, said computers comprising at least one computer associated with at least one client and at least one computer associated with a seller, said computer associated with at least one client having at least one display device enabling a visual display containing the digital information delivered to said computer of the client via said network and at least one input device, said input device enabling the client to erect a network connection to said computer of said seller, comprising the steps of
a) transmitting a first information about the identity of said at least one client from said computer associated with at least one client to said computer associated with the seller;
b) transmitting a second information relating to the selection of a product from said computer associated with at least one client to said computer associated with the seller;
c) determining the properties, processing parameters, design parameters, or performance characteristics of said product by means of a consulting software;
d) transmitting a third information about the properties, processing parameters, design parameters, or performance characteristics of said product from said computer associated with the seller to said computer associated with at least one client;
e) determining a quantity for the amount of utilization of said consulting software by said client;
f) storing said quantity.

10. A computer-implemented method according to claim 9 comprising the additional step of ordering said product wherein a rebate is credited to said client depending on the quantity of the utilization of the method by the client.

11. A computer-implemented method according to claim 9 wherein the rebate depends additionally on further details of the client.

12. A computer-implemented method according to claim 9 wherein said client is identified by username and password or by digital information stored on the client's computer and transferred to said computer of the seller.

13. A computer-implemented method according to claim 9 wherein the consulting software verifies whether a product can be used for an intended purpose.

14. A computer-implemented method according to claim 13 wherein the contact details of a consultant are automatically displayed, or an email link to the consultant is automatically displayed, or a message is automatically sent to a consultant with details about the intended purpose of said product and about said client, or the client is advised to buy a product from said company or another company if said product should not be used for the intended purpose.

15. A computer-implemented method according to claim 10 wherein the duration for which the consulting software runs, or the number of arithmetic operations performed by the consulting software, or the duration of the arithmetic operations performed by the consulting software, or the number of accesses to the consulting software is used for quantifying the utilization by the client.

16. An apparatus for marketing goods comprising:
a) a database for storing information about a client,
b) a first consulting software component for selecting a product or determining properties, processing parameters, design parameters, or performance characteristics of a product by a client;
c) a second software component for determining a quantity for the utilization of the consulting software by said client and for storing said quantity in said database;
d) a connection component for establishing a connection to a digital network enabling data transfer between said computer associated with at least one client and said computer associated with the company selling or producing designated goods.

17. An apparatus according to claim 16 comprising additionally a third software component for quantifying a rebate for a certain product depending on said quantity for the utilization.

18. An apparatus according to claim 16, wherein said consulting software enables the selection of a product or relates to the intended purpose of a certain product.

19. An apparatus according to claim 17, wherein the duration for which the consulting software runs, or the number of arithmetic operations performed by the consulting software, or the duration of the arithmetic operations performed by the consulting software, or the number of accesses to the consulting software is used for quantifying the utilization by the client.
